(19) United States
(12) Patent Application Publication
(10) Pub. No.: US 2016/0132448 A1
(43) Pub. Date: May 12, 2016

(54) HUB MODULE WITH A SINGLE BRIDGE SHARED AMONG MULTIPLE CONNECTION PORTS TO SUPPORT ROLE REVERSAL

(71) Applicant: TEXAS INSTRUMENTS INCORPORATED, Dallas, TX (US)

(72) Inventors: Win Naing MAUNG, Plano, TX (US); Suzanne Mary VINING, Plano, TX (US); Nirav Jayanti PATEL, Dallas, TX (US)

(21) Appl. No.: 14/935,082

(22) Filed: Nov. 6, 2015

Related U.S. Application Data
(60) Provisional application No. 62/076,688, filed on Nov. 7, 2014.

(51) Int. Cl. G06F 13/366; G06F 13/42; G06F 13/40

(52) U.S. Cl. CPC G06F 13/366; G06F 13/4068; G06F 13/4282; G06F 13/4027

(57) ABSTRACT

An apparatus includes a multiport hub, a single bridge configured to communicatively couple together a plurality of hosts and to emulate a slave device to each such host, and a plurality of connection port. The apparatus further includes a configurable data path network coupled to the multiport hub, the single bridge, and the plurality of connection ports. The configurable data path network is configured to selectively provide for a connection port for which a host is detected, data communications through the single bridge between the multiport hub and the connection port, and for a connection port for which no host is detected, data communications between the multiport hub and the connection port that bypass the single bridge. Corresponding methods are also so disclosed.

### CROSS-REFERENCE TO RELATED APPLICATIONS

The present application claims priority to U.S. Provisional Patent Application No. 62/076,688, filed Nov. 7, 2014, titled “Autonomous Role Reversal Arbitration Amongst Multiple Remote USB Hosts To Connect To A Local USB Host Using Only One Host To Host Bridge Without Dedicating A HUB Downstream Port To The Bridge,” which is hereby incorporated herein by reference in its entirety.

### BACKGROUND

The Universal Serial Bus (USB) protocol is a host-centric protocol in which a host initiates transactions with a client device. That is, the client device cannot initiate transactions on the bus. USB On The Go (OTG) is protocol that permits role reversal in which either USB device can be a host or a client device. That is, the USB controller of one device can operate as a host while the USB controller of the other device operates as a client device, or vice versa. USB OTG allows USB devices such as printers or smart phones to act as a host while allowing other USB devices such as USB flash drives or cameras to be attached to them. The use of USB OTG allows the roles of such devices to switch back and forth between host and client device. For example, a smart phone may operate as a host device to read data from a removable media, but then present itself as a USB mass storage device (client device) when connected to a host computer.

### BRIEF DESCRIPTION OF THE DRAWINGS

For a detailed description of various examples, reference will now be made to the accompanying drawings in which:

FIG. 1 shows a system diagram of a multi-port hub module which supports role reversal while minimizing the number of bridges used in accordance with various examples;

FIG. 2 illustrates the operation of the hub module of FIG. 1 in accordance with various examples;

FIG. 3 shows a block diagram of a direction control circuit and how it detects that an apparatus connected to a corresponding port is a host device in accordance with various examples;

FIG. 4 illustrates how an apparatus identifies itself as a slave device in accordance with various examples; and

FIG. 5 illustrates a method in accordance with various examples.

### DETAILED DESCRIPTION

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct wired or wireless connection. Thus, if a first device couples to a second device, that connection may be through a direct connection or through an indirect connection via other devices and connections.

The embodiments described herein include a hub module that permits one or more bus apparatuses to be communicatively coupled to a local host system. Embodiments of the hub module are described in the context of a USB bus, but the disclosed principles may apply to other bus protocols besides USB.

As noted above, USB is a host-centric protocol. This in turn means that two hosts generally cannot be connected together via a USB connection. However, with the use of a bridge, two hosts can be connected together via the USB protocol. The bridge is coupled between the two hosts and emulates a slave device to each respective host. Thus, each host determines that it is communicating with a slave device in accordance with the USB protocol. A USB hub permits multiple USB apparatuses to be communicatively coupled to one host. In accordance with the preferred embodiments, the disclosed USB hub module does not require, and thus does not include, a separate bridge for each of its respective ports. Instead, the USB hub module includes a single bridge which is operationally shared between the various USB connection ports on the hub module. A host that is connected to one of the USB hub module's connection ports uses the single bridge in the hub module to communicate with the local host also coupled to the hub module. The remaining connection ports on the hub module may be connected to slave devices and do not need, and thus do not use, the single bridge to communicate with the local host.

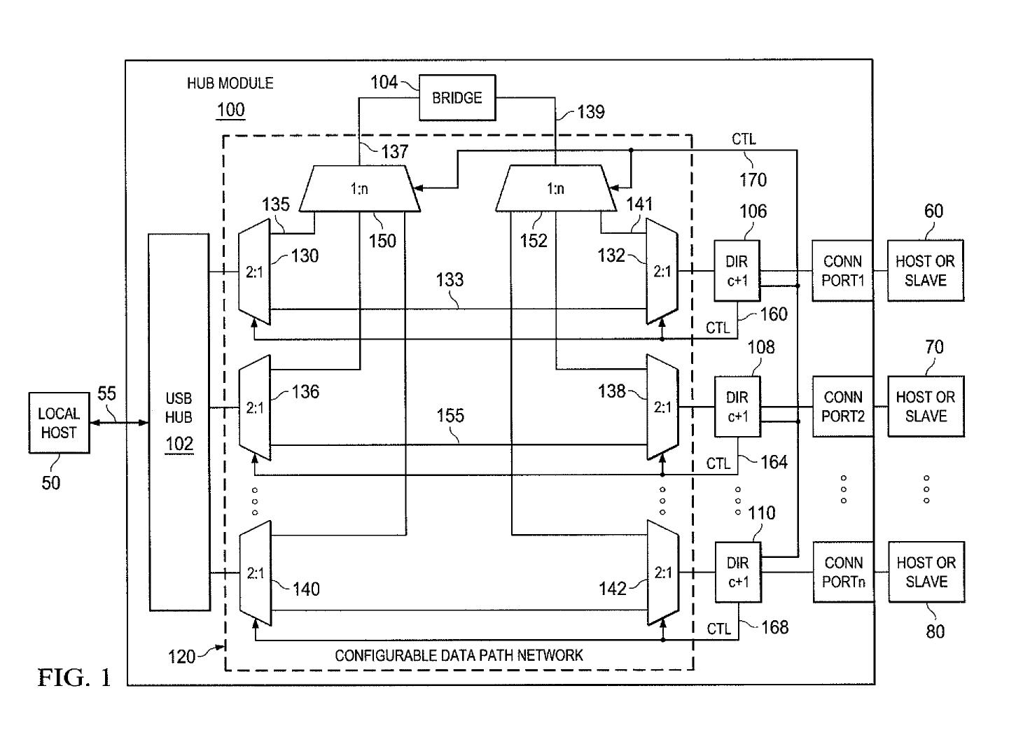

FIG. 1 shows a system which includes a hub module 100 for coupling one or more bus apparatuses 60, 70, and 80 to a local host 50. Each bus apparatus 60, 70, and 80 may itself function as a host or a slave device. As such, these devices are referred as “apparatus” rather than a device to avoid confusion with the term “slave device.” Each such apparatus 60, 70, 80 may be a computer or other type of host, or a slave device such as a smart phone, storage device, etc. The local host 50 may be a computer such as a laptop or notebook computer or any other type of computing system which has USB connectivity and functions as a host of the USB bus.

The hub module 100 includes a multiport USB hub 102 which permits any apparatus 60, 70, 80 coupled to the hub module 100 to be communicatively coupled to the local host 50. The hub module 100 also provides multiple connection ports designated as Connection Port 1, Connection Port 2, . . . , Connection Port n. Each connection port may include a connector to which an apparatus 60-80, or a cable from the apparatus, may be connected. Further, the hub module 100 includes a bridge 104 (e.g., a USB bridge). The bridge includes an electrical circuit that emulates a slave device to the local host 50 and also emulates a slave device to any host coupled to a connection port to thereby permit two hosts to be communicatively coupled together via the bridge 104 of the hub module 100.

In the embodiment of FIG. 1, the hub module 100 includes only a single bridge 104, not multiple bridges. For example, the hub module 100 does not include a separate bridge 104 corresponding to each connection port. By including only one bridge 104, use of the single bridge 104 is shared between the various connection ports depending on whether and which connection port has a host connected thereto. For example, if Connection Port 1 has a host connected to it, then bridge 104 provides the slave device emulation function between local host 50 and the host of Connection Port 1. In that case, the bridge 104 is not used with respect to Connection Ports 2-n. Of course, if only Connection Port 2 has a host connected to it, then the bridge 104 is coupled to Connection Port 2 so as to provide the proper slave device emulation function with regard to Connection Port 2.

Referring still to FIG. 1, the hub module 100 also includes a configurable data path network 120. The configurable data path network 120 includes various multiplexers. In the example of FIG. 1, the configurable data path network 120 includes a pair of multiplexers for each connection port to permit communications between the connection port and the multiport hub to selectively pass through the bridge 104 or to bypass the bridge. With respect to Connection Port 1, the pair of multiplexers includes multiplexers 130 and 132. With respect to Connection Port 2, the pair of multiplexers includes multiplexers 136 and 138. With respect to Connection Port n, the pair of multiplexers includes multiplexers 140 and 142. Multiplexers 130, 132, 136, 138, 140, and 142 are 2:1 multiplexers in the example of FIG. 1.

The configurable data path network 120 also includes a pair of multiplexers 150 and 152 coupled to the bridge 104 to selectively provide communications between one of the connection ports and the bridge and between the bridge and the multipart hub 102. Multiplexers 150 and 152 are 1:n multiplexers, where n equals the number of connection ports in hub module 100.

The hub module 100 also includes a plurality of direction control circuits 106, 108, 110—each direction control circuit corresponding to a separate connection port and configured to differentiate as to whether a host or a slave device is coupled to the respective connection port. For example, direction control circuit 106 determines whether apparatus 60 is a host or a slave device. Similarly, direction control circuit 108 determines whether apparatus 70 is a host or a slave device, and direction control circuit 110 determines whether apparatus 80 is a host or a slave device. The direction control circuits 106, 108, 110 in turn assert various control signals (labeled as “CTL” in FIG. 1) to control the state of the various multiplexers of the configurable data path network 120. Direction control circuit 106 asserts control signals 160 to its corresponding multiplexers 130, 132. Direction control circuit 108 asserts control signals 164 to its corresponding multiplexers 136, 138. Direction control circuit 110 asserts control signals 168 to its corresponding multiplexers 140, 142. Further, the direction control circuits 106-110 communicate with each other and control multiplexers 150, 152 via control signals 170. By controlling the state of the multiplexers of the configurable data path network 120, the bridge 104 is communicatively coupled to only one of the connection ports—the particular connection port that has a host connected to it.

With respect to Connection Port 1, multiplexers 130 and 132 provide a communication path from the USB hub 102 to the connection port along signal path 133. This path is used if a slave device is coupled to Connection Port 1 and thus the bridge 104 is not needed. Signal path 133 permits communications between the local host 50 and the slave device connected to Connection Port 1 to bypass the bridge 104. If a host device is coupled to Connection Port 1, the multiplexers 130, 132, 150, and 152 are configured so as to enable a communication path through the bridge 104 along signal lines 135, 137, 139, and 141. As such, communications between the local host 50 and the apparatus connected to Connection Port are selectively provided either through signal line 133 to bypass the bridge 104, or through multiplexers 150 and 152 to include the bridge 104.

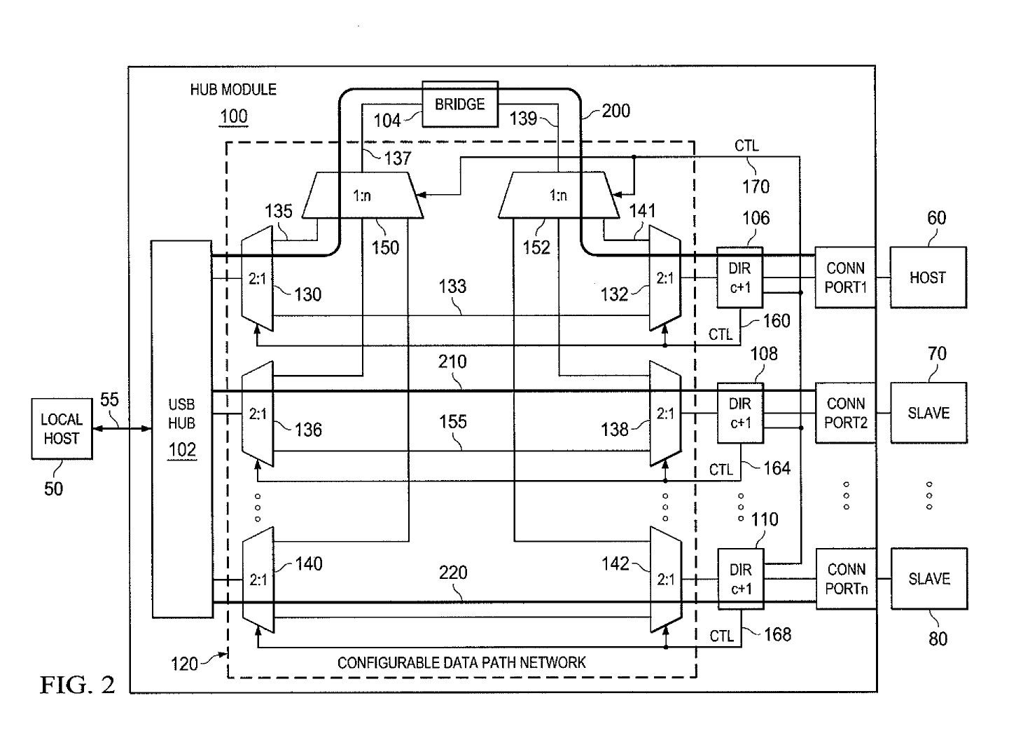

FIG. 2 shows an operational example of the hub module 100. In this example, the apparatus 60 connected to Connection Port 1 is a host, and the apparatuses 70 and 80 connected to Connection Port 2 and Connection Port n are slave devices. The various multiplexers of the configurable data path network 120 are configured to implement the communication paths (bold lines) shown between the local host 50 and the various host and slave devices 60-80. Communication path 200 includes the bridge 104 to permit hosts 50 and 60 to communicate with each other. Because apparatuses 70 and 80 are slave devices, the bridge 104 is not needed for such slave devices to communicate with local host 50 and thus communications between the slave devices and the local host 50 flow along communication paths 210 and 220, respectively.

Referring back to FIG. 1 and as noted previously, the direction control circuits 106-110 communicate with each other. The inter-direction control circuit communication implements an arbitration process when more than one host is coupled to the connection ports. Signal lines 170 implement communication links between the direction control circuits 106-110 over which each direction control circuit is configured to communicate to the other direction control circuits as to whether a host or a slave device is coupled to its connection port. If two or more hosts are coupled to connection ports, then the direction control circuits arbitrate among themselves to determine a “winning” direction control. Only a winning direction control circuit of the arbitration can configure the configurable data path network so that communications between the multiport hub and the connection port corresponding to the winning direction control circuit pass through the bridge 104, and communications between the multiport hub 102 and all other connection ports pass through the configurable data path network 120 but not through the bridge 104. In some embodiments, the arbitration process is that the direction control circuit 106-110 to first detect the presence of a host is the winning direction control circuit. Thus, when a direction control circuit detects the presence of a host, that direction control circuit sends a signal to the other direction control circuits indicating that it has detected a host. That signal prevents the other direction control circuits from trying to configure the multiplexers of the configurable data path network 120 to include bridge 104

In other embodiments, each direction control circuit 106-110 may have a unique identifier, and the identifiers may be used in the arbitration process to decide a winning direction control circuit. For example, between two direction control circuits that each have detected a host, the direction control circuit with the highest (or lowest) value identifier is deemed to be the winning direction control circuit.

As explained herein, the direction control circuits 106-110, and not the local host 50, are configured to provide the control signals to configure the multiplexers of the configurable data path network 120. As such, the connection link 55 between the local host 50 and the hub module 100 is a standard USB connection and no sideband signals are provided between local host 50 and hub module 100 for configuration of the configurable data path network. That is, the direction control circuits 106-110 can detect the type of apparatuses (host or slave) connected to the connection ports and, as such, can configure the configurable data path network themselves rather than relying on the local host 50 to do the configuration.

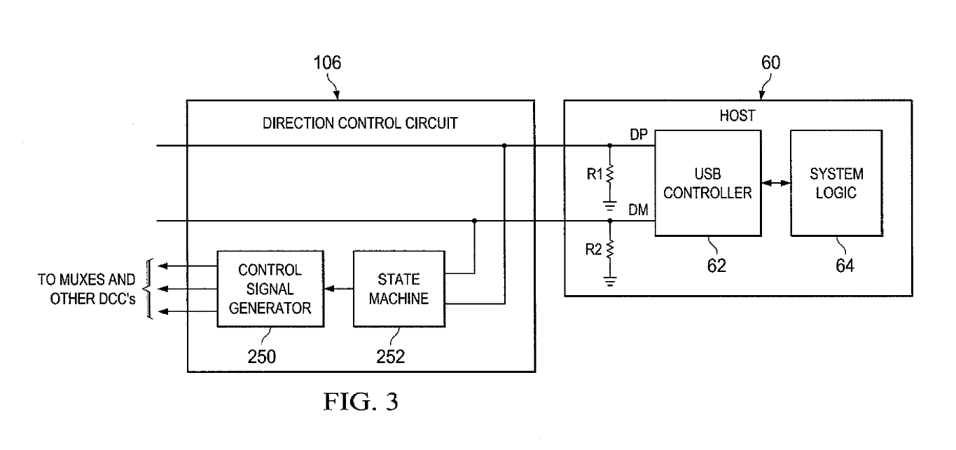

FIG. 3 illustrates direction control circuit 106 coupled to an apparatus 60 which functions as a host. The architecture shown for direction control circuit 106 may be the same for the other direction control circuits. The direction control circuit 106 includes a control signal generator 250 and a state machine 252. The state machine 252 senses the voltage levels on the data signal lines from the apparatus 60. In the example of a USB apparatus, the data signal lines are differential signals DP and DM (D+ and D−). The state machine 252 receives the DP and DM signals to aid the state machine in determining the role of the USB apparatus 60 connected to Connection Port 1 (not specifically shown in FIG. 3 for clarity). Based on determining that an apparatus is connected to the connection port and its role (e.g., host in the example of FIG. 3), the state machine 252 causes the control signal generator 250 to generate the appropriate control signals to configure the multiplexers in the configurable data path network 120.

In accordance with the USB specification, a host USB apparatus is to include pull-down resistors (e.g., 15 kohms) on both of its DP and DM signal lines. A USB low speed client device is to include a pull-up resistor on its DM signal line but not on its DP signal line. A USB full speed or high speed client device is to include a pull-up resistor on its DP signal line, but not its DM signal line. As such, when a host first connects (prior to data signaling or routing through multiplexers, both of the DP and DM signal lines will be a logic 0 level for a host. However, when a client device first connects (prior to data signaling), one of the signal lines will be a logic 1 while the other is a logic 0 depending on whether the client device is a low speed or full/high speed device.

FIG. 3 shows an example of a USB apparatus 60 that is a host. As such, both signal lines have pull-down resistors. Those resistors are illustrated in FIG. 3 as pull-down resistors R1 and R2, respectively. Determining the logic state of the DP and DM signal lines to both be 0, however, is not enough information to determine that a host is actually connected to the connection port. Whether a host is connected to the connection port or no apparatus at all is connected, a logic 0 will be present on both sensed data signal lines. Thus, the state machine 252 performs an active detection process in which it injects a known current onto one or both of the data signal lines and measures the resulting voltage. The resulting voltage will be within a predetermined range if a pull-down resistor is present or at a different voltage level if no pull-down resistor is present (which would be the case if no apparatus is connected). By injecting a current onto one or both of the DP and DM signal lines and measuring the resulting voltage, the state machine 252 can determine whether or not an apparatus is connected to the connection port. By sensing the logic state of the DP and DM signal lines on the connection port and performing an active detection process, the state machine 252 can determine whether an apparatus is connected to the port as well as its role (host versus client device).

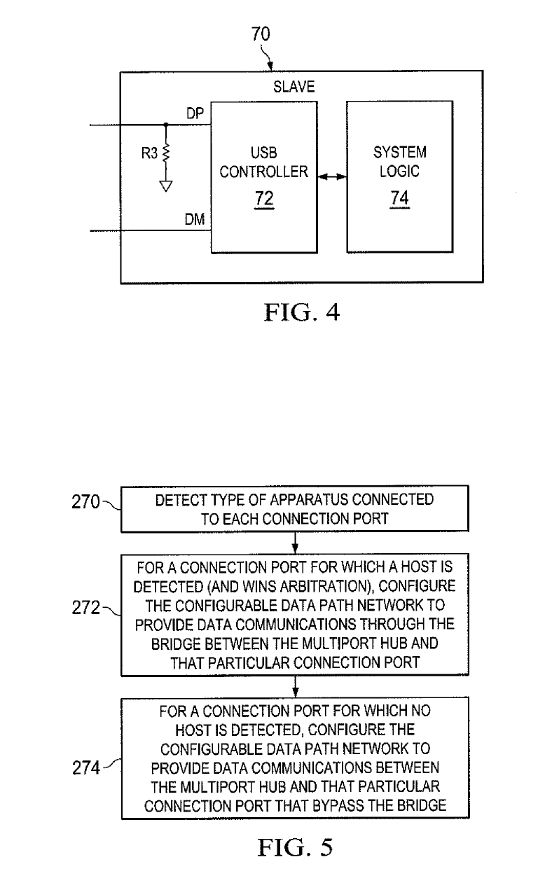

FIG. 4 shows an example of an apparatus 70 functioning as a slave device and thus only one of the data signal lines has a pull-up resistor R3. The single pull-up resistor thus indicates to the state machine 252 that the apparatus is a slave device. For purposes of role reversal using a multi-port USB and a single bridge 104, the state machine 252 does not need to specifically differentiate the role of the device as a low speed client device versus a full/high speed client device, but such a differentiation can be made in some embodiments.

The host 60 of FIG. 3 may include a USB controller 62 and system logic 64. The system logic 64 provides the host 60 with its intended functionality which is application specific. Similarly, the slave device 70 of FIG. 4 also includes a USB controller 72 and system logic 74. The system logic 74 provides the slave device 70 with its intended functionality which is application specific.

FIG. 5 illustrates a method in accordance with various embodiments. The various operations shown in FIG. 5 may be performed in the order shown, or in a different order. Further, the operations may be performed sequentially, or two or more of the operations may be performed concurrently. At 270, the method includes detecting the type of apparatus, if any, connected to each connection port. This operation may be performed by the state machine 252 as explained above.

At 272, the method includes, for a connection port for which a host is detected (and that wins arbitration if multiple hosts are attached to the connection ports), configuring the configurable data path network 120 to provide data communications through the bridge 104 between the multiport hub 102 and that particular connection port. Configuring the configurable data path network 120 may include configuring the various multiplexers such that communications between the multiport hub 102 and the host flow through the pair of multiplexers associated with that connection port as well as multiplexers 150 and 152, and thus through the bridge 104.

At 274, the method includes, for a connection port for which no host is detected, configuring the configurable data path network to provide data communications between the multiport hub and that particular connection port that bypass the bridge 104. For example, for a slave device connected to Connection Port 2, the method includes configuring multiplexers 136 and 138 in FIG. 1 to provide communications along signal path 155.

The above discussion is meant to be illustrative of the principles and various embodiments of the present disclosure. Numerous variations and modifications will become apparent to those skilled in the art once the above disclosure is fully appreciated. For example, a hub module may, in some examples, include multiple connection ports and multiple bridges, and the total number of bridges in the hub module may be less than the total number of connection ports. In such examples, a configurable data path network may be configurable to allow each of the multiple bridges to be connected to all or respective subsets of the connection ports. It is intended that the following claims be interpreted to embrace all such variations and modifications.

What is claimed is:

1. An apparatus, comprising:
a multiport hub;
a plurality of direction control circuits, each of the direction control circuits corresponding to a separate connection port and configured to differentiate as to whether a host or a slave device is coupled to the respective connection port;
a bridge configured to communicatively couple together a plurality of hosts and to emulate a slave device to each of the hosts; and
a configurable data path network coupled to the multiport hub, the direction control circuits, and the bridge;
wherein each of the direction control circuits is configured to provide control signals to the configurable data path network to configure data communications between the multiport hub and the connection port corresponding to the direction control circuit based on whether the respective direction control circuit determines that a host or a slave device is coupled to the port.

2. The apparatus of claim 1, further comprising wherein the apparatus includes only one bridge configured to communicatively couple together the plurality of hosts and to emulate the slave device to each of the hosts.

3. The apparatus of claim 1, further comprising communication links between the direction control circuits over which each of the direction control circuits is configured to communicate to the other direction control circuits whether a host or a slave device is coupled to a connection port corresponding to the respective direction control circuit.

4. The apparatus of claim 3, wherein the direction control circuits are configured to perform an arbitration among themselves when at least two of the direction control circuits determine that a host is coupled to the respective connection ports.

5. The apparatus of claim 4, wherein only a winning direction control circuit of the arbitration is to configure the configurable data path network so that communications between the multiport hub and the connection port corresponding to the winning direction control circuit pass through the bridge, and communications between the multipart hub and all other ports pass through the configurable data path network but not through the bridge.

6. The apparatus of claim 4, wherein the winning direction control circuit of the arbitration is a first direction control circuit to detect a host.

7. The apparatus of claim 1, wherein the configurable data path network includes:
a pair of multiplexers for each of the connection ports to permit communications between the respective connection port and the multiport hub to selectively pass through the bridge or to bypass the bridge; and
a pair of multiplexers coupled to the bridge to selectively provide communications between one of the ports and the bridge and between the bridge and the multiport hub.

8. The apparatus of claim 1, wherein the multipart hub and the bridge comprise a universal serial bus (USB) multiport hub and a USB bridge.

9. The apparatus of claim 1, wherein the configurable data path network comprises a plurality of multiplexers to provide configurable data communication paths between the multiport hub and the connection ports, and wherein the direction control circuits and not a host are configured to provide control signals to configure the multiplexers of the configurable data path network.

10. An apparatus, comprising:
a multiport hub;
a single bridge configured to communicatively couple together a plurality of hosts and to emulate a slave device to each such host;
a plurality of connection ports; and
a configurable data path network coupled to the multiport hub, the single bridge, and the plurality of connection ports, wherein the configurable data path network is configured to selectively provide:
for a connection port for which a host is detected, data communications through the single bridge between the multiport hub and the connection port; and
for a connection port for which no host is detected, data communications between the multiport hub and the connection port that bypass the single bridge.

11. The apparatus of claim 10, further comprising a plurality of direction control circuits, wherein each of the direction control circuits corresponds to a separate connection port and is configured to differentiate as to whether a host or a slave device is coupled to the respective connection port.

12. The apparatus of claim 11, further comprising communication links between the direction control circuits over which each of the direction control circuits is configured to communicate to the other direction control circuits whether a host or a slave device is coupled to a connection port corresponding to the respective direction control circuit.

13. The apparatus of claim 11, wherein the direction control circuits are configured to perform an arbitration among themselves when at least two direction control circuits determine that a host is coupled to the respective connection ports.

14. The apparatus of claim 13, wherein the arbitration is based on which direction control circuit first detects a presence of a host, and wherein the first direction control circuit to detect a host configures the configurable data path network so that the communications only between the multiport hub and the connection port corresponding to the direction control circuit pass through the single bridge.

15. The apparatus of claim 10, wherein the configurable data path network includes:
a pair of multiplexers for each of the connection ports to permit communications between the respective connection port and the multiport hub to selectively pass through the single bridge or to bypass the single bridge; and
a pair of multiplexers coupled to the single bridge to selectively provide communications between one of the ports and the single bridge and between the single bridge and the multiport hub.

16. The apparatus of claim 17, wherein the multiport hub and the single bridge comprise a universal serial bus (USB) multiport hub and a single USB bridge.

17. A method, comprising:
detecting whether a host is connected to a connection port;
for a connection port for which a host is detected, configuring a configurable data path network to provide data communications through a bridge between a multiport hub and that particular connection port, wherein the bridge is configured to emulate a slave device to a host; and
for a connection port for which no host is detected, configuring the configurable data path network to provide data communications between the multiport hub and the particular connection port that bypass the bridge.

18. The method of claim 17, wherein configuring the configurable data path network includes configuring a plurality of multiplexers.

19. The method of claim 17, wherein configuring the configurable data path network to provide data communications through a bridge between the multiport hub and the connection port comprises configuring a pair of multiplexers that are shared by all of the connection ports.

20. The method of claim 17, further comprising:
detecting multiple hosts connected to connection ports;
performing an arbitration process to determine a winning connection port; and
configuring the configurable data path network to provide data communications through the bridge only between the multiport hub and the winning connection port, so that the configurable data path network does not permit communications through the bridge to any other connection port.
